(19) United States
(12) Patent Application Publication
(10) Pub. No.: US 2016/0210341 A1
(43) Pub. Date: Jul. 21, 2016

(54) CAPACITY PLANNING FOR DATABASE REPLICATION LATENCY

(71) Applicant: Linkedln Corporation, Mountain View, CA (US)

(72) Inventors: Zhenyun Zhuang, Belmont, CA (US); Haricharan K. Ramachandra, Fremont, CA (US); Cuong H. Tran, Los Altos, CA (US); Subbu Subramaniam, Sunnyvale, CA (US); Chavdar Botev, Sunnyvale, CA (US); Chaoyue Xiong, Milpitas, CA (US); Badrinath K. Sridharan, Saratoga, CA (US)

(73) Assignee: LINKEDIN CORPORATION, Mountain View, CA (US)

(21) Appl. No.: 14/607,755

(22) Filed: Jan. 28, 2015

Related U.S. Application Data
(60) Provisional application No. 62/104,584, filed on Jan. 16, 2015.

(51) Int. Cl. G06F 17/30

(52) U.S. Cl. CPC G06F 17/30575; G06F 17/30321

(57) ABSTRACT

A system, methods, and apparatus are provided for performing capacity planning within a system that experiences high volumes of data having high velocity and high variability. Based on historical traffic, a forecast is generated for one or more relatively coarse time periods (e.g., weeks, days), and is decomposed to yield finer-grained forecasts (e.g., for hours, minutes) by applying a distribution index also generated from historical traffic. Estimated replication latency for the forecast period can be calculated from the traffic forecast and an expected level of replication capacity. Further, a required amount of replication capacity can be determined based on a traffic forecast and a maximum replication latency permitted by a service level agreement (SLA) of an event consumer. In addition, replication headroom can be computed, to identify a maximum level of traffic that can be sustained without violating an SLA and/or a date/time at which a violation may occur.

### RELATED APPLICATION

This application claims priority to U.S. Provisional Patent Application No. 62/104,584, which was filed Jan. 16, 2015 and is incorporated herein by reference.

### BACKGROUND

This disclosure relates to the field of computer systems. More particularly, a system, methods, and apparatus are provided for performing capacity planning.

Online applications and services are often characterized by large volumes of data representing various events, such as logins, content requests, content deliveries, and so on. Many of these applications and services replicate event data to promote fault tolerance, ensure data consistency, and/or other purposes. Due to the high volume of data that is processed, it is critical to provide adequate resources for supporting data replication and for measuring and controlling latency in the data replication process.

### DESCRIPTION OF THE FIGURES

FIG. 1 is a block diagram depicting a computing environment in which effective capacity planning is desired, in accordance with some embodiments.

FIG. 2 is a flow chart illustrating a method of forecasting a future rate of traffic, in accordance with some embodiments.

FIG. 3 is a flow chart illustrating a method of determining expected replication latency, in accordance with some embodiments.

FIG. 4 is a flow chart illustrating a method of determining necessary replication capacity, in accordance with some embodiments.

FIG. 5 is a flow chart illustrating a method of determining replication headroom, in accordance with some embodiments.

FIG. 6 is a block diagram of an apparatus for performing capacity planning, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, methods, and apparatus are provided for performing capacity planning within a system that receives and handles high volumes of data with high velocity and high variability. For example, the system may host an online application or service that has multitudinous users and that processes many events, perhaps on the order of a billion events per day, or more.

A given event may relate to a user login, a content request received from a device operated by a user, serving of one or more types of content to a user-operated device, receipt of new information from a user device (e.g., a message, a post, a comment), and so on. Components of the system may subscribe to or be otherwise configured to consume any or all events. For example, an event that reflects an update to user data (e.g., a user profile) may be consumed by a service, feature, or component that maintains such data or that propagates the update to other, related data. In order to satisfy event consumers, some or all events are replicated and made available to interested consumers.

More particularly, in some embodiments, after a new event is received and recorded in a first repository, it is then replicated or published so that interested consumers can receive it. The consumers may be local to and/or remote from the system component that received or generated the event. In some implementations, event replication allows events that occur or that are registered in one location (e.g., one data center) to be propagated to other locations (e.g., other data centers), for consumption by event consumers, for backup, for fault tolerance, and/or other reasons.

Replication latency refers to the delay that occurs after a new event occurs and before that event is available to event consumers. In particular, replication latency in some embodiments may be defined as the delay between the time a new event is initially stored or recorded and the time at which a data consumer can receive (e.g., pull) it. In order to manage replication latency, effective capacity planning within the system is desired, but such planning may differ from one set of circumstances or from one environment to another.

In some embodiments, effective capacity planning involves determining and/or using any or all of several parameters. These parameters may include, but are not limited to, past and/or future traffic rates (i.e., rates of arrival of new events), replication latency, available replication capacity, replication headroom, and a suitable replication latency requirement of an event consumer's SLA (Service Level Agreement).

In these embodiments, a traffic rate and replication capacity may be expressed in terms of events per second, and replication latency may be expressed in terms of seconds or other time units (e.g., minutes, milliseconds). A past or historical traffic rate parameter reflects how many events were received or generated within the system during a particular time period, as detected by a storage system that initially records the events, for example, and a future or forecasted traffic rate identifies a prediction for some future period of time. Replication capacity is a measure of how quickly the system makes events available to consumers, and may reflect a current measurement, a past measurement, or a forecast for a future time period. A past or historical replication latency reflects actual measurement of the latency experienced by one or more past events, while a future or forecasted replication latency is a prediction for a future time period. Instead of an actual measurement or forecast for a specific discrete time period, a given value (e.g., traffic rate, replication capacity, replication latency) may be an average of values measured or predicted for multiple time periods.

Replication headroom may have multiple aspects, such as a maximum traffic rate that can be handled without violating (or likely violating) an event consumer's SLA, or a date or time at which the forecasted traffic rate is expected to (or is likely to) violate an event consumer's SLA.

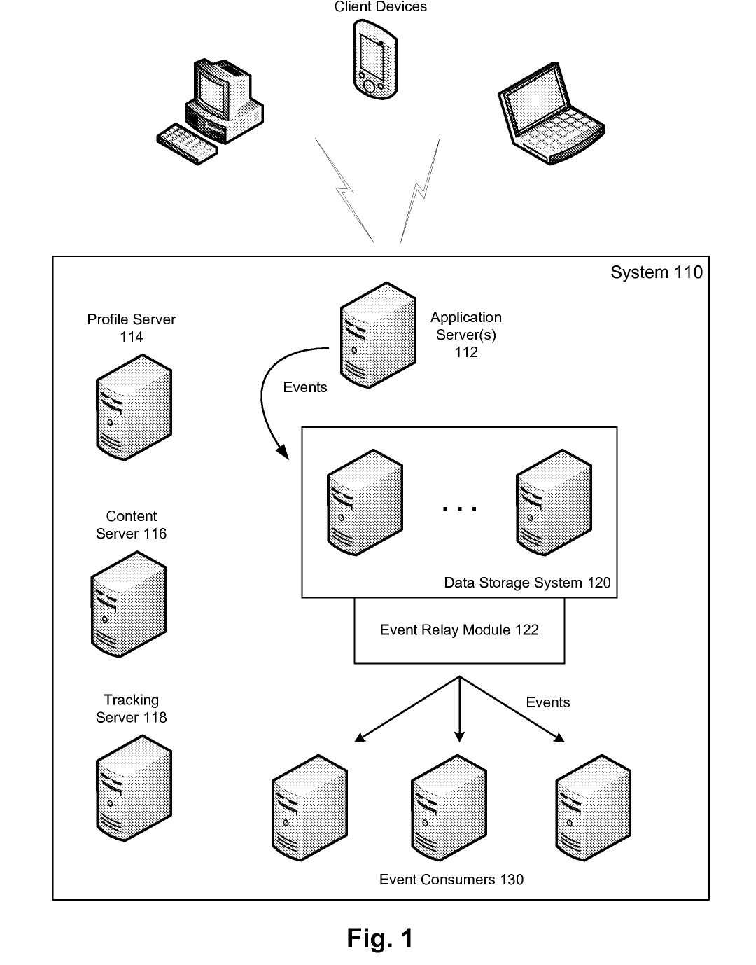

FIG. 1 is a block diagram of a computing environment in which effective capacity planning is desired, according to some embodiments.

In these embodiments, system 110 is (or is part of) a data center or other collection of computer resources that hosts a professional or social networking service that helps members create, develop, and maintain professional (and personal) relationships, as provided by LinkedIn® Corporation for example. In other embodiments, system 110 may support or host an application, service, or web site that stores, maintains, and publishes some other type or types of content.

System 110 may be reproduced or copied at multiple different sites or data centers, and event replication as described herein may involve replication of events within one data center and/or across multiple data centers or sites. Reference to a system for performing capacity planning may thus refer to system 110 of FIG. 1 or a larger system that includes system 110.

Users of a service or services hosted by system 110 connect to the system via client devices, which may be stationary (e.g., desktop computer, workstation) and/or mobile (e.g., smart phone, tablet computer, laptop computer). The client devices operate suitable client applications, such as a browser program or an application designed specifically to access a service offered by system 110.

Content served by system 110 includes messages, status updates, comments, advertisements, offers, announcements, job listings, news, informative articles, activities of other users, and so on, and may be or may include any type of media (e.g., text, graphics, image, video, audio). Content items published or served by system 110 may include content generated by users of the system's services and/or content supplied by third parties for delivery to users of those services.

Users of system 110 may be termed members because they may be required to register with the system in order to fully access the available service or services. Members may be identified and differentiated by username, electronic mail address, telephone number, and/or some other unique identifier.

Interactive user/member sessions are generally made through application server(s) 112 or, alternatively, a web server or some other portal, gateway, or entry point. The server or portal through which a given member session is established may depend on the member's device or method of connection. For example, a user of a mobile client device may connect to system 110 via a different portal (or set of portals) than a user of a desktop or workstation computer.

Data storage system 120 comprises multiple storage engines, which may be of different types or the same type. Illustrative storage engines include third-party databases, database management systems, a file system, and/or other entities that include or that manage data repositories. Individual data storage devices (e.g., disks, solid-state drives) may be part of individual storage engines and/or may be separate entities coupled to storage engines within data storage system 120.

System 110 also includes profile server 114, content server 116, and tracking server 118, any or all of which may be omitted in other embodiments or copies of system 110.

Profile server 114 maintains profiles, which may be stored in data storage system 120 or elsewhere (e.g., a profile database), of members of the service(s) hosted by system 110. An individual member's profile may reflect any number of attributes or characteristics of the member, including personal (e.g., gender, age or age range, interests, hobbies, member ID), professional (e.g., employment status, job title, functional area or industry, employer, skills, endorsements, professional awards), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify who sent a message, to identify a recipient of a status update, to select content to serve to the member or an associated member, to record a content-delivery event).

Organizations may also be members of the service (i.e., in addition to individuals), and may have associated descriptions or profiles comprising attributes such as industry (e.g., information technology, manufacturing, finance), size, location, goal, etc. An “organization” may be a company, a corporation, a partnership, a firm, a government agency or entity, a not-for-profit entity, an online community (e.g., a user group), or some other entity formed for virtually any purpose (e.g., professional, social, educational).

Content server 116 maintains content items for serving to members (e.g., in data storage system 120, in a content repository), an index of the content items, and/or other information useful in serving content to members. Illustratively, content server 116 may serve on the order of hundreds of millions of items every day. Content server 116 may include a recommendation module for recommending content to serve to a member, or recommendations may be generated by some other component of system 110 (not depicted in FIG. 1).

Tracking server 118 monitors and records activity of system 110 and/or members (e.g., in distributed data storage system 120, in a tracking database). For example, whenever content is served from the system (e.g., to a client device), the tracking server is informed of what is served, to whom (e.g., which member), when it was served, and/or other information. Similarly, the tracking server also receives notifications of member actions regarding content, to include identities of the member and the content acted upon, the action that was taken, when the action was taken, etc. Illustrative actions that may be captured include, but are not limited to, clicks/taps/pinches (on the content, on a logo or image), conversions, follow-on requests, visiting a page associated with a subject or provider of the content, taking some other action regarding the content (e.g., posting it, commenting on it, sharing it, following or endorsing its provider, liking it), and so on.

Events generated during or as a result of a member session are delivered to data storage system 120 for initial storage. The events may be generated, triggered, or initiated by client devices, application server(s) 112, profile server 114, content server 116, tracking server 118, and/or other components of system 110 that support the applications/services offered by the system.

After being recorded in data storage system 120, some or all events are replicated and published, broadcast, or otherwise made available to event consumers 130 by event relay module 122. Event relay module 122 may be part of data storage system 120 or may be separate. Event consumers may pull individual events, and/or may receive selected events that are pushed to them automatically. An event relay module operating as part of system 110 in one location or data center may make events available to event consumers operating in some other location or data center remote from system 110. Event consumers may include various components of system 110 that perform various functions, and may include profile server 114, content server 116, and/or tracking server 118.

System 110 may include other components not illustrated in FIG. 1. For example, in some embodiments, system 110 includes a connection server that stores data representing members' associations/connections/relationships. Illustratively, the members' associations may be stored as a graph in which each node corresponds to one member or user, and each edge between two nodes corresponds to a relationship between the members/users represented by the two nodes. The network of members of a service offered by system 110 may number in the tens or hundreds of millions, and the graph of members' associations may be stored on one or more components of data storage system 120.

Members of a service hosted by system 110 have corresponding pages (e.g., web pages, content pages) on the system, which they may use to facilitate their activities with the system and with each other, to form connections/relationships with other members, inform friends and/or colleagues of developments in their lives/careers, etc. These pages (or information provided to members via these pages) are available to some or all other members. Members' pages may be stored within data storage system 120 and/or elsewhere.

Functionality of system 110 may be distributed among its components in an alternative manner, such as by merging or further dividing functions of one or more components, or may be distributed among a different collection of components. Yet further, while depicted as separate and individual hardware components (e.g., computer servers) in FIG. 1, one or more of application server 112, profile server 114, content server 116, tracking server 118, and event relay module 122 may alternatively be implemented as separate software modules executing on one or more computer servers. Thus, although only a single instance of a particular component of system 110 may be illustrated in FIG. 1, it should be understood that multiple instances of some or all components may be employed.

In addition to storing new events (e.g., in data storage system 120) a computing environment such as system 110 of FIG. 1 also retains past events and/or data reflecting past events. For example, a system in which capacity planning is performed as indicated in embodiments discussed herein retains records indicating historical traffic rates, which may also be termed event rates. In different implementations, these data may have different levels of granularity.

In one implementation, for example, historical rates are hourly in nature, meaning that for each of multiple past hours, the system can provide a count of the amount of traffic (or events) that were experienced in that hour. In another implementation, traffic rates may reflect other time periods (e.g., minutes, days, weeks). Similarly, historical measurements may be retained for replication capacities, replication latencies, relevant requirements of event consumers (e.g., in terms of latencies permitted by their SLAs), etc.

One or more distribution indexes (or “seasonal indexes”) are generated to summarize and reflect historical traffic rates. For example, a weekly distribution index may reflect one historical week of traffic, on a per-day basis (i.e., with 7 data points, each point representing one day's traffic), a per-hour basis (i.e., with 168 data points, each point representing one hour's traffic), or some other basis. An hourly distribution index would reflect one historical hour of traffic, a daily distribution index would reflect one historical day, a monthly distribution index would reflect one historical month, and so on. Alternatively, a given (e.g., weekly) distribution index may reflect the average of multiple corresponding periods (e.g., weeks) of traffic.

To illustrate the composition of a distribution index, consider a weekly distribution index that reflects one historical week of traffic or the average (or other combination) of multiple past weeks. In this index, a given data point in the index identifies the percentage of the week's traffic that was received during the day, hour, or other time period associated with the data point. If the time periods are days, there will be 7 data points; if the time periods are hours, there will be 168 data points. Thus, if the data points correspond to hours, for an illustrative hour in which the system handled 43 million events, during a week in which 5 billion events were processed, the corresponding data point might be assigned a value of 0.0086 because 0.86% of the week's events were handled that hour.

To support effective capacity planning, some or all of the parameters listed previously may be calculated. In particular, a capacity planning task may involve calculation and/or use of any or all of the following:
1) Forecasted future traffic rate—based on historical traffic;
2) Expected replication latency—based on forecasted traffic rate and current or expected replication capacity;
3) Required replication capacity—based on forecasted traffic rate and replication latency required by event consumers' SLAs; and
4) Expected headroom—based on forecasted traffic rate, current/expected replication capacity and replication latency required by event consumers' SLAs.

In addition, a capacity planning effort may also or instead involve configuring an event consumer's SLA, or at least determining how such an SLA could be configured in terms of replication latency. For example, from the calculations above, a maximum replication latency expected to be experienced (e.g., during a week, a month, a year) may be identified and used to specify a maximum value for the replication latency metric in an event consumer's service level agreement.

In some service level agreements, however, the event replication latency may be defined differently (i.e., not as a simple maximum). For example, an SLA may dictate that the replication latency must be less than some value (e.g., 60 seconds) for X % of events (e.g., 95%, 99%) consumed by the consumer during a given time period (e.g., one day, one week). As another example, a replication latency metric may be restricted to exceeding a threshold value (e.g., 60 seconds) for no more than a threshold period of time (e.g., 1 minute, 1% of a given time period).

Because any given replication latency that is experienced may only be problematic if it causes an event consumer's service level agreement to be abrogated, it is helpful to be able to configure that SLA accurately and in a form that is enforceable and that is beneficial to the consumer. In embodiments described herein, it is assumed that a latency restriction in a service level agreement is defined as a maximum latency (e.g., a value that is not to be exceeded); in other embodiments, other forms may be enforced.

In some embodiments in which the granularity of time is hourly (e.g., hourly aggregated measures and/or forecasts of traffic/events can be obtained), the following notation is used during capacity planning operations. The rate of incoming events that are to be replicated is denoted as T_{i,j} for day i and hour j (e.g., 0≦j≦23 or 1≦j≦24). Replication latency is represented by L_{i,j}, and replication capacity is denoted as C_{i,j}. The latency restriction of a service level agreement (e.g., the maximum permitted replication latency) is represented by Lₛₗₐ.

In performing calculation (1) listed above—forecasting a future traffic rate—in some embodiments any numbers or types of suitable models may be applied. Illustratively, it may be determined that one model is well-suited for a given system or a given environment, in which case that model's result may always (or usually) be applied. Or, two or more models may be applied and the average or a weighted mean of their results may be calculated and applied, or one of their results may be adopted over the others. For example, selected models may be applied to some period of historical (past) traffic and the results (i.e., the subsequent traffic that the models forecasted) compared with the actual traffic that was encountered in order to determine which model is most accurate for the environment.

In some embodiments, two models used to forecast future traffic rates include a time-series model and regression analysis. In some implementations, the ARIMA (Autoregressive Integrated Moving Average) model is the time-series model.

In these embodiments, a two-step approach is used in the process of forecasting future traffic. First, a model is applied to some recent period of time (e.g., 4 weeks, 6 weeks, 12 weeks), with a relatively coarse granularity (e.g., days, weeks), to produce a coarse forecast for a suitable future period of time (e.g., 2 weeks, 3 weeks, 6 weeks). Second, a suitable distribution index that matches the granularity is applied to distribute or decompose the coarse forecast to a finer level (e.g., minutes, hours). Thus, if the coarse forecast encompasses the following 3 weeks (or 21 days), a weekly distribution index may be applied to each week's (or each day's) aggregate value (representing the expected number of events to be received during the week or day) to distribute the forecasted traffic among, for example, the individual hours of the week (or day).

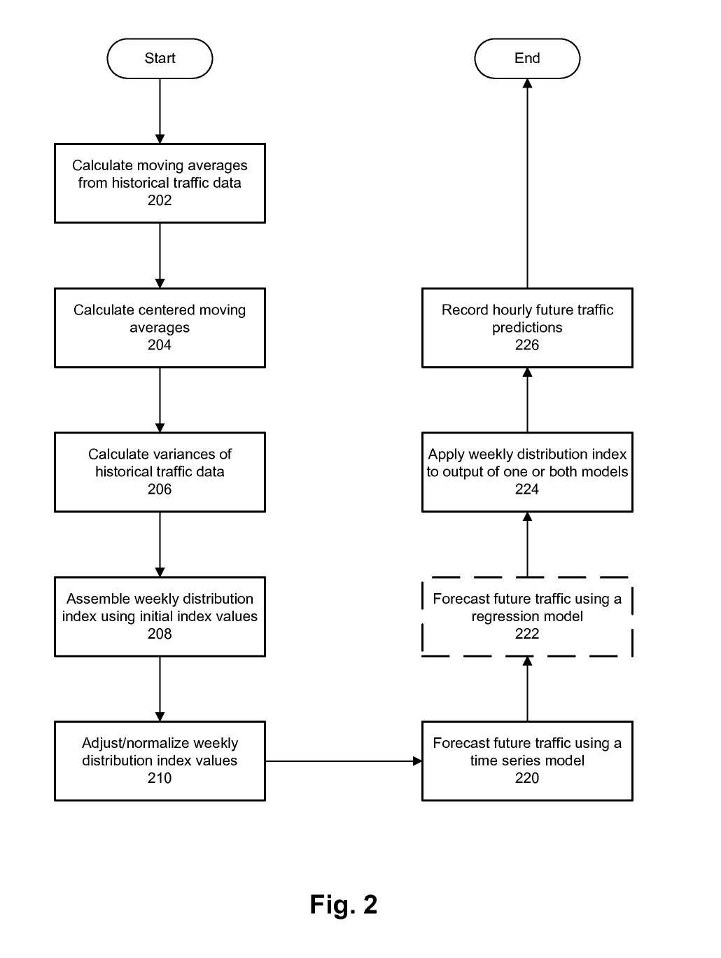

FIG. 2 is a flow chart illustrating a method of forecasting a future rate of traffic, according to some embodiments. In other embodiments, one or more of the illustrated operations may be omitted, repeated, or performed in a different order. Accordingly, the specific arrangement of operations shown in FIG. 2 should not be construed as limiting the scope of the embodiments.

In these embodiments, historical data regarding past traffic are expressed in hourly values. Actual measurements may be available for each of multiple hours or, alternatively, finer-grained measurements (e.g., per minute, per five minute period) may be aggregated to yield hourly values. In other embodiments, historical data values may be expressed with values corresponding to other time periods (e.g., minutes, multiple minutes, multiple hours, days). As indicated above and as will be seen below, the historical data are used to generate a distribution index, which will allow traffic rates forecasted from the historical data on a larger time scale (e.g., days, weeks) to be decomposed to match the hourly granularity of the historical data, thereby providing forecasts for hourly intervals of time.

In these embodiments, six weeks of historical traffic rates are used to generate and distribute or decompose three forecasted weeks of future traffic among individual hours of those weeks. In other embodiments, past traffic rates covering differ spans of time may be used to generate forecasts covering different time periods.

In operation 202, creation of a weekly distribution index (which may alternative be termed a weekly seasonal index) begins with calculation of moving averages for each hour of a recent week (or some other week) of historical traffic data. In particular, for each hour of the 168 consecutive historical hourly traffic rates/volumes in the selected week, a moving average is calculated. A given data point value may reflect a traffic rate observed or estimated at a given point in time corresponding to the associated hour, or may represent the number of events received during the hour divided by 3600 seconds. Alternatively, a data point may identify the total number of events received/observed during that hour.

Thus, where Xₜ represents a historical traffic rate for a given hour t (e.g., 0≦t≦168), the moving average (MA) for that hour may be calculated as:

$${MA}_{t} = \frac{{\sum }_{i = - 83}^{84} {X}_{t + i}}{168}$$

Moving averages for some or most of the selected week's data points will use data values for periods before or after the selected week. For example, calculation of the moving average for the first data point (e.g., t=0) will rely upon historical traffic rates observed for the preceding 83 hours (within the previous week).

It may be noted that 169 moving averages are calculated in the illustrated embodiment, for values of t ranging from 0 to 168. The 169 moving averages are needed in order to calculate 168 centered moving averages, as discussed immediately below.

In operation 204, centered moving averages are computed that better represent the time-series data. Specifically, because the target period of 168 hours has an even number of data points/values, the moving averages do not correspond exactly to their respective hours. Therefore, for each hourly data point, a centered moving average (CMA) is calculated from the moving averages of neighboring data points, for t=0 to 167:

$${CMA}_{t} = \frac{{MA}_{t} + {MA}_{t + 1}}{2}$$

In operation 206, variances (V) are calculated for each hourly data point in the time-series data by dividing the historical value for that hour by the centered moving average (for t=0 to 167):

$${V}_{t} = \frac{{X}_{t}}{{CMA}_{t}}$$

In operation 208, for each of the 168 hours of the historical week being used to generate the weekly distribution index, the hour's corresponding initial value within the index (e.g., IIₜ for hour t) is calculated as the ratio of its variance to the total variance of all 168 hours:

$${II}_{t} = \frac{{V}_{t}}{{\sum }_{i = 0}^{167} {V}_{i}}$$

In operation 210, the final, normalized, values of the weekly distribution index are computed. An illustrative final value is denoted as Iₜ for hour t, and is calculated by multiplying its initial value IIₜ by 168 and dividing that product by the summation of the initial values, as follows:

$${I}_{t} = \frac{{II}_{t} \times 168}{{\sum }_{i = 0}^{167} {II}_{t}}$$

As shown below, these index values I, when multiplied by a forecasted future week of traffic/events, will yield hourly traffic/events for each hour in the forecasted week. The forecasted future week of traffic/events may incorporate an adjustment representing an observed growth in traffic (e.g., as measured over some suitable time period), or such adjustment may be applied when the weekly distribution index is applied to the week's forecast.

In operation 220, a suitable time-series model is applied to historical data, possibly including the data that was used to generate the weekly distribution index, to yield one or more weeks of forecasted traffic/events. For example, the six most recent weeks of traffic/events may be input to the model to receive as output a forecast for three future weeks.

In some implementations, the AMNIA (p,d,q) (AutoRegressive Integrated Moving Average) time-series model is used, in which parameters p, d, and q refer to the order of the autoregression, integration, and moving average aspects of the model, respectively. Through experimentation and/or data analysis, it has been found that ARIMA(7,1,0) functions well for a computing environment such as that of FIG. 1, which may support operation of a professional social network.

The input to the time-series model, in the illustrated embodiment, is a set of data including the daily observations or measurements of traffic during the six weeks of historical traffic, which amounts to 42 data points. The output of the model is a set of 21 daily values indicating the amount (i.e., number) of events that are expected to be received or handled each day of the three forecasted weeks.

To prepare for application of the weekly distribution index that was generated above, each week's daily values are aggregated to produce one forecast for the week's traffic. As discussed below, each of the three weekly forecasts will be distributed among the hours of that week.

In some embodiments, the time series model may be configured to directly output hourly forecasts for some future time period (e.g., one week, three weeks), in which case the forecast may be used as-is during capacity planning (i.e., without applying a distribution index), or may be broken down into smaller time periods (e.g., minutes, five-minute intervals) with a finer-grained distribution index. In other embodiments, the time-series model may produce weekly forecasts (instead of daily), to which a weekly distribution index can be immediately applied.

In optional operation 222, a suitable regression analysis model is applied to generate the traffic forecast. In particular, based on a graph of historical traffic values, wherein each past week is represented by one point indicating the total amount of traffic (e.g., number of events) received during that week or the equivalent rate (e.g., in events/second), a trending line is obtained that allows the values for the future weeks to be predicted.

The output of the regression analysis, therefore, is one value for each forecasted week, representing the amount of traffic (e.g., number of events) forecasted to be received that week or the equivalent rate.

In operation 224, the output of one or both models is distributed, using the weekly distribution index, to produce hourly traffic predictions. In particular, for each hour of a future week, its predicted traffic is determined by multiplying the prediction for that week by the corresponding hour's value in the index.

As discussed previously, in different implementations (e.g., for different computing/application environments), only the time-series model may be applied to produce future hourly predictions, only the regression model may be applied, both may be applied, and/or some other model(s) may be applied to generate a coarse prediction that is decomposed using a corresponding distribution index. If multiple models are applied, all but one result may be discarded, or some or all may be averaged (or combined in some other manner) to yield forecasts.

In operation 226, the future hourly traffic predictions are recorded, at least temporarily, for use in other aspects of a capacity planning scheme, such as calculations (2) through (4) identified above (in paragraph [0040]) and described below.

More specifically, based on the estimated, forecasted, or predicted future traffic obtained via the method of FIG. 2, or some other suitable process, other capacity planning data can be generated, such as the replication latency L that can be expected for the traffic, the replication capacity C needed to support the traffic without violating an event consumer's service level agreement (at least as it pertains to replication latency), and headroom.

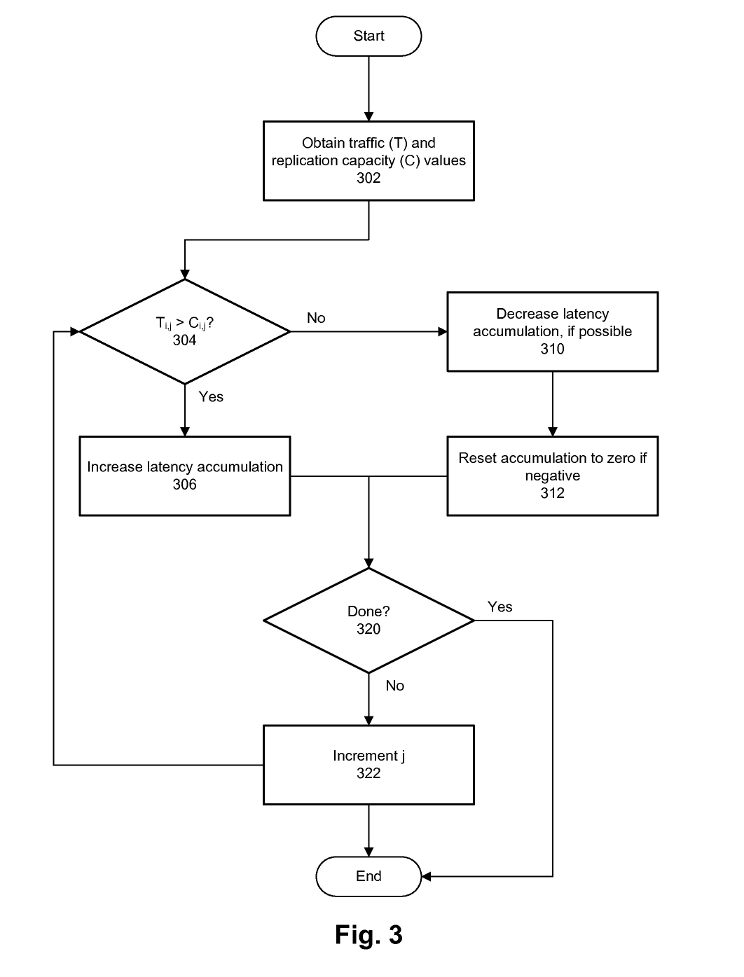

FIG. 3 is a flow chart illustrating a method of calculating replication latency expected for a given rate or amount of traffic, according to some embodiments. In other embodiments, one or more of the illustrated operations may be omitted, repeated, or performed in a different order. Accordingly, the specific arrangement of operations shown in FIG. 3 should not be construed as limiting the scope of the embodiments.

In this method, traffic rate is represented as T_{i,j} for day i and hour j, which may be in the future (i.e., as part of a traffic forecast) or may be a past measurement. The replication latency for the same time period is denoted as L_{i,j}, and the calculation assumes a particular replication capacity available at that time. The calculation assumes that each day begins with no accumulated or carry-over latency. In other words, it is assumed that each day begins (at hour 0) with no replication latency, such that L_{i,0}=0 for each day i. Thereafter, during each day, accumulation of latency will depend on how the current traffic rate compares to the available replication capacity.

Although the illustrated method is described as it may be performed for a single day, it may be repeated as many times as desired for other days.

In operation 302, for each hour j of day i for which expected replication latency is to be calculated, the values of T_{i,j} and C_{i,j} are retrieved from memory, from storage, or calculated/estimated as described herein.

In operation 304, T_{i,j} and are compared. For hour j=1, for example, the forecasted traffic T_{i,l} is compared to the corresponding replication capacity C_{i,l}. Illustratively, each value may be expressed as a total number of events received or expected to be received (for T), or a total number of events that can be processed without delay (for C), divided by 3600, which yields corresponding rates (i.e., events per second). In some other implementations, the traffic and replication capacity values may simply be the total number of events received/expected to be received during the hour and the total number of events that can be processed without delay during the hour.

If the current traffic exceeds capacity, the method continues at operation 306. Otherwise, if the capacity is greater than or equal to the traffic, the method advances to operation 310.

In operation 306, replication latency accumulates. The accumulation (and therefore the current latency estimation or measurement) may be calculated as:

$${L}_{i , j} = {L}_{i , j - 1} + \frac{3600 ( {T}_{i , j} - {C}_{i , j} )}{{C}_{i , j}}$$

After operation 306, the method advances to operation 320.

In operation 310, capacity exceeds or matches the traffic. If the capacity matches the traffic, accumulated latency will not change; if it exceeds traffic, accumulated latency (if any) will decrease. In particular, the current latency estimation or measurement can be calculated as:

$${L}_{i , j} = {L}_{i , j - 1} + \frac{3600 ( {C}_{i , j} - {T}_{i , j} )}{{C}_{i , j}}$$

In operation 312, if the current indicated latency is negative, it is reset to zero.

In operation 320, if latency for every hour has been calculated, the method ends. Otherwise, the method continues at operation 322

In operation 322, the value of j, the current hour for which calculations are being performed, is incremented, and the method returns to operation 304. Each time operation 304 is revisited, the comparison of traffic and capacity values is made for the next hour (as incremented in operation 322).

In some embodiments, latency predictions may be made with finer (or coarser) granularity than hourly. For example, an hourly forecast of expected traffic may be distributed among shorter time periods (e.g., minutes, multiple minutes), using a corresponding hourly distribution index, by equally distributing the hour's expected traffic among the time periods, etc. In these embodiments, it may be possible to identify a particular time period during which a maximum latency is expected to occur.

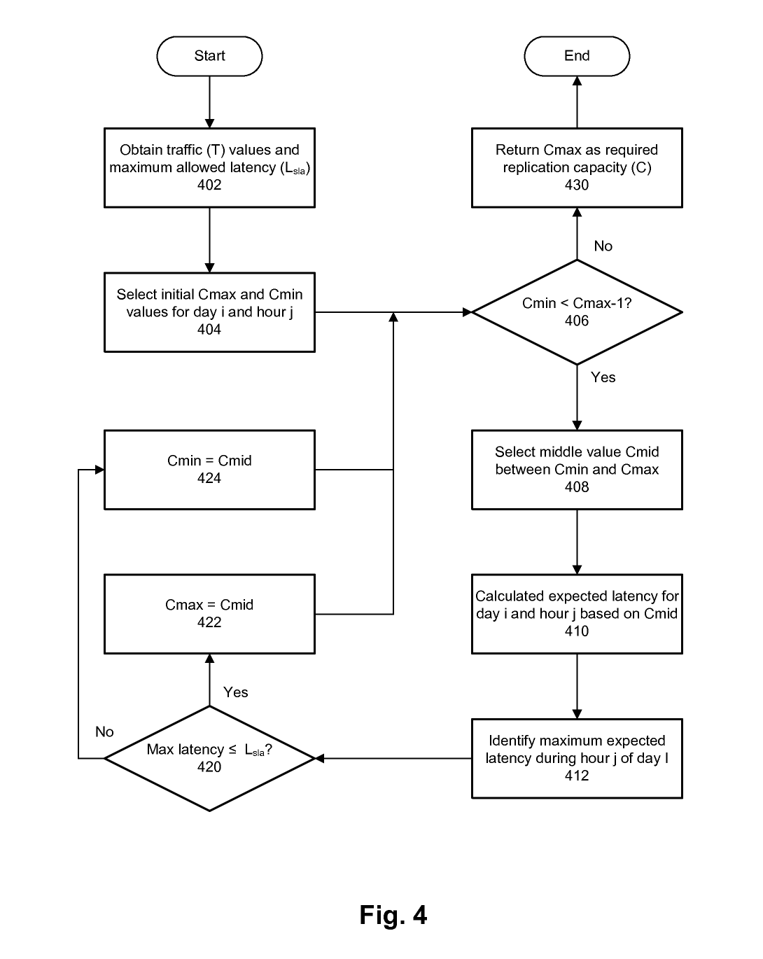

FIG. 4 depicts a method of determining necessary replication capacity, according to some embodiments. In other embodiments, one or more of the illustrated operations may be omitted, repeated, or performed in a different order. Accordingly, the specific arrangement of operations shown in FIG. 4 should not be construed as limiting the scope of the embodiments.

In this method, traffic rate is represented as T_{i,j} for day i and hour j, which may be in the future (i.e., as part of a traffic forecast) or the past. The calculation generated via this method identifies the replication capacity C_{i,j} that is necessary at hour j of day i in order to satisfy a replication latency metric Lₛₗₐ of an event consumer (e.g., the event consumer with the most restrictive or stringent replication latency metric).

The replication capacity may be expressed as a rate (e.g., events per second) or as a total number of events that must be processed within the corresponding time frame (e.g., hour j of day i). The latency metric Lₛₗₐ represents a maximum replication latency that is permitted (e.g., 100 seconds, 1 minute) during that time frame. In other embodiments, Lₛₗₐ may be expressed in some other way, such as a latency that must be equaled or excelled for some percentage of a time frame.

In the illustrated method, a sequence of one or more predictions is made regarding a replication capacity that will allow the forecasted traffic/events to be handled without violating Lₛₗₐ. For each prediction, the maximum latency that would be expected to occur is compared to Lₛₗₐ. If that maximum latency is greater than Lₛₗₐ or is less than Lₛₗₐ by some threshold or some percentage, a newer, better prediction is made. Successive predictions may be based on a binary search pattern in some implementations; other search patterns or schemes may be used in other implementations.

In operation 402, for each hour j of day i for which the necessary replication capacity is to be calculated, the values of are retrieved from memory, from storage, or calculated/estimated as described herein. In addition, the maximum allowed latency value is obtained for use as Lₛₗₐ, which may illustratively be the highest latency value that does not violate any event consumer's service level agreement.

In operation 404, initial values Cmin_{i,j} and Cmax_{i,j} are selected to bound the search for the required capacity C_{i,j}, Cmin_{i,j} is a replication capacity that, for the forecasted traffic T_{i,j}, will likely or certainly cause a latency value that exceeds Lₛₗₐ, and that therefore is known to be too low to be used as C_{i,j}. In the illustrated embodiments, Cmin_{i,j}=0 or some other nominal value.

Conversely, Cmax_{i,j} is a replication capacity that, for the forecasted traffic T_{i,j}, will likely or certainly cause a latency value that is less than Lₛₗₐ, but which is nonetheless unacceptable for use as C_{i,j} because there are other capacities that yield higher latencies that are nonetheless acceptable. Accepting higher latency that does not violate an SLA allows the system to dedicate fewer resources to processing the traffic.

In some embodiments, a measure of the highest traffic rate ever encountered, or the highest rate encountered during some time period, may be noted and may be adopted as Cmax_{i,j}. In other embodiments, a default value for Cmax_{i,j} may be selected that is known to provide sufficient capacity to avoid accumulating any latency or only low values of latency (e.g., 10,000; 20,000; 100,000).

In operation 406, a logic loop is initiated that repeats as long as

Cmin_{i,j}<Cmax_{i,j}−1

The constant 1 may be replaced with a different value in other embodiments. When this condition is no longer true, the method advances to operation 430.

In operation 408, the average of the minimum (Cmin_{i,j}) and maximum (Cmax_{i,j}) capacity values is calculated. This middle value is denoted as Cmid_{i,j}:

$${Cmid}_{i , j} = \frac{{Cmin}_{i , j} + {Cmax}_{i , j}}{2}$$

The calculated middle value may be rounded up or down (e.g., to an integer value).

In operation 410, the replication latency L_{i,j} that is or would be expected to result from adoption of Cmid_{i,j} as the necessary replication capacity for day i and hour j is calculated. In the illustrated method, the expected replication latency is calculated using the method depicted in FIG. 3. In other embodiments, other methods are applied.

In operation 412, the maximum replication latency that was noted during calculation of L_{i,j} is noted. In some embodiments, this value is the same as L_{i,j}, but in other embodiments that operate with finer time granularity (e.g., five-minute intervals), the latencies predicted for hour j of day i may fluctuate among those finer time intervals, in which case the maximum predicted is recorded.

In operation 420, the maximum replication latency value is compared to the maximum permitted replication latency Lₛₗₐ. If the maximum predicted latency is less than or equal to the maximum allowed latency, the method continues with operation 422; otherwise, the method advances to operation 424.

In operation 422, the current maximum replication capacity value Cmax_{i,j} is set equal to the middle/average value calculated or selected in operation 408 (Cmid_{i,j}). After operation 422, the method returns to operation 406.

In operation 424, the current minimum replication capacity value Cmin_{i,j} is set equal to the middle/average value calculated or selected in operation 408 (Cmid_{i,j}). After operation 424, the method returns to operation 406.

In operation 430, Cmax_{i,j} is returned as the replication capacity C_{i,j} required for day i, hour j, to handle the forecasted traffic T_{i,j} without exceeding Lₛₗₐ.

After operation 430, the method may end or may return to operation 404 to calculate the required replication capacity for a different hour and/or day.

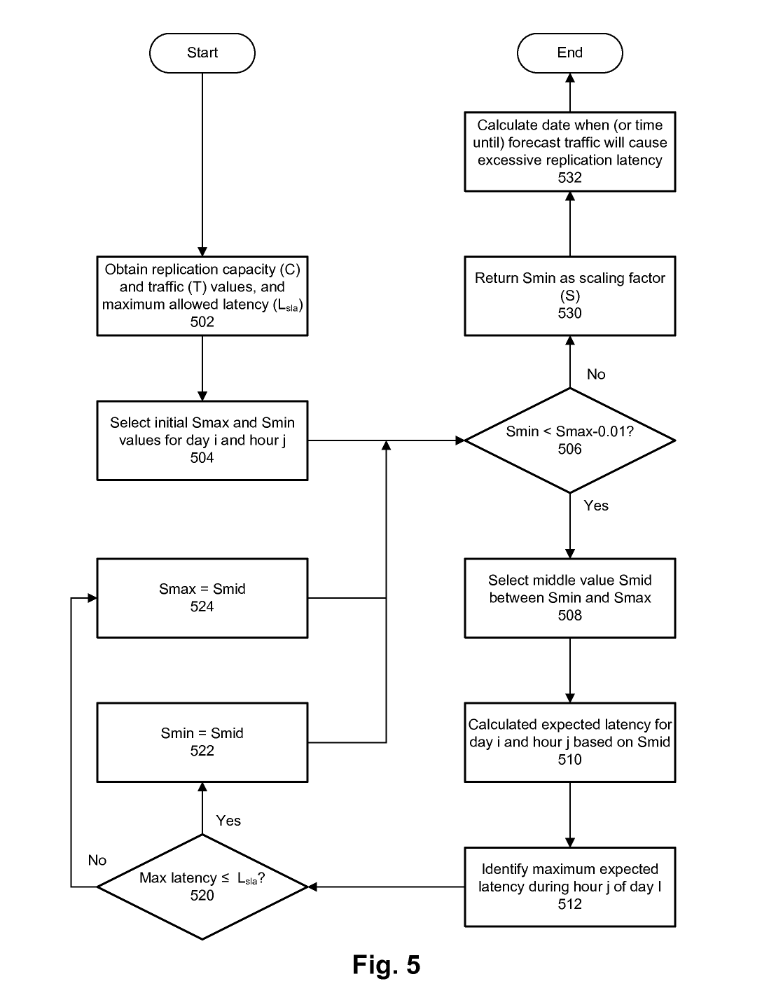

FIG. 5 depicts a method of calculating replication headroom, according to some embodiments. In other embodiments, one or more of the illustrated operations may be omitted, repeated, or performed in a different order. Accordingly, the specific arrangement of operations shown in FIG. 5 should not be construed as limiting the scope of the embodiments.

In this method, traffic rate is represented as Tᵢⱼ for day i and hour j, which may be in the future (i.e., as part of a traffic forecast) or the past, and which may be expressed as a rate (e.g., events per second) or as a total number of events expected to be received during the hour. The replication capacity that is available (or that is expected to be available) for that day and hour is represented as C_{i,j}. The replication capacity may be expressed as a rate (e.g., events per second) or as a total number of events that can be processed, or a number of events that the system is believed able to process, within the corresponding time frame (e.g., hour j of day i).

The calculations performed in this method identify two aspects of the replication headroom. First, a scaling factor is identified that, when multiplied by the expected traffic rate T_{i,j}, yields the highest traffic rate that can likely be supported without violating a replication latency metric Lₛₗₐ of an event consumer (e.g., the event consumer with the most restrictive or stringent replication latency metric). Second, a future date at which (or a time period until) traffic T will likely reach that highest traffic rate is calculated, based on an observed or estimated traffic growth rate (e.g., a growth rate experienced over the past year or some other historical period).

The latency metric Lₛₗₐ is the maximum replication latency that is permitted (e.g., 100 seconds, 1 minute) during that time frame for an event consumer (e.g., the event consumer SLA with the most restrictive replication latency metric). In other embodiments, Lₛₗₐ may be expressed in some other way.

In the illustrated method, a sequence of one or more predictions is made regarding a scaling factor that, when applied to a particular traffic forecast T_{i,j} will allow the scaled number of traffic/events to be handled without violating Lₛₗₐ.

For each candidate scaling factor, the maximum latency that would be expected to occur if the forecasted traffic were scaled by that factor is compared to Lₛₗₐ. If that maximum latency is greater than Lₛₗₐ or is less than Lₛₗₐ by some threshold or some percentage, a newer, better prediction is made. Successive predictions may be based on a binary search pattern in some implementations; other patterns or schemes may be used in other implementations.

In operation 502, for each hour j of day i for which headroom replication is to be calculated, the values of T_{i,j} and C_{i,j} are retrieved from memory, from storage, or calculated/estimated as described herein. In addition, the maximum allowed latency value is obtained for use as Lₛₗₐ, which may illustratively be the highest latency value that does not violate any event consumer's service level agreement.

In operation 504, initial values Smin_{i,j} and Smax_{i,j} are selected to bound the search for the appropriate scaling factor. Smin_{i,j} is a scaling factor that, when applied to (e.g., multiplied by) the forecasted traffic T_{i,j}, will likely or certainly yield a level of traffic that will exhibit replication latency that is lower than and therefore does not violate Lₛₗₐ. In some embodiments, Smin_{i,j}=0 or 1 or some other nominal value.

Conversely, Smax_{i,j} is a scaling factor that, when applied to the forecast traffic T_{i,j}, will likely or certainly cause latency that exceeds Lₛₗₐ. In some embodiments, a scaling factor that, if applied to the forecast traffic, would yield the highest traffic rate ever encountered, or the highest rate encountered during some time period, may be noted and may be adopted as Smax_{i,j}. In other embodiments, a default value for Smax_{i,j} may be selected that is large enough to undoubtedly scale the forecasted traffic rate beyond a point at which replication latency would exceed Lₛₗₐ.

In operation 506, a logic loop is initiated that repeats as long as

Smin_{i,j}<Smax_{i,j}−0.01

The constant value 0.01 may be replaced with some other value in other embodiments. When this condition is no longer true, the method advances to operation 530.

In operation 508, the average of the minimum (Smin_{i,j}) and maximum (Smax_{i,j}) values is calculated. This middle value is represented as Smid_{i,j}:

$${Smid}_{i , j} = \frac{{Smin}_{i , j} + {Smax}_{i , j}}{2}$$

The calculated middle value may be rounded up or down (e.g., to yield a real number with the desired precision).

In operation 510, the replication latency L_{i,j} that is or that would be expected to result from a traffic rate of T_{i,j} as scaled by Smid_{i,j} is calculated. In the illustrated method, the expected replication latency is calculated using the method depicted in FIG. 3. In other embodiments, other methods are applied.

In operation 512, the maximum replication latency that was noted during calculation of L_{i,j} is noted. In some embodiments, this value is the same as L_{i,j}, but in other embodiments, that may operate with finer time granularity (e.g., five-minute intervals), the latencies predicted for hour j of day i may fluctuate among those finer time intervals, in which case the maximum predicted is recorded.

In operation 520, the maximum predicted replication latency is compared to the maximum permitted replication latency Lₛₗₐ. If the maximum predicted latency is less than or equal to the maximum allowed latency, the method continues with operation 522; otherwise, the method advances to operation 524.

In operation 522, the minimum scaling value Smin_{i,j} is set equal to the middle/average value calculated or selected in operation 508 (Smid_{i,j}). After operation 522, the method returns to operation 506.

In operation 524, the maximum scaling value Smax_{i,j} is set equal to the middle/average value calculated or selected in operation 508 (Smid_{i,j}). After operation 524, the method returns to operation 506.

In operation 530, Smin_{w} is returned as the scaling factor for day i, hour j, thereby indicating that the forecast traffic T_{i,j} could be increased to a value equivalent to T_{i,j}*S_{i,j} without experiencing replication latency that exceeds Lₛₗₐ.

In operation 532, the date at which forecast traffic will match or exceed the scaled traffic rate of T_{i,j}*S_{i,j} is determined or, alternatively, the amount of time that will pass (e.g., days, weeks, months) until the forecasted traffic will match (or exceed) the scaled traffic rate. This calculation depends on an historical growth rate, which may be a yearly rate, a monthly rate, or may have some other periodicity.

In some embodiments, this operation involves fitting a curve to some number of data points representing historical traffic levels, and using that curve to obtain the desired date. For example, linear regression may be applied to fit a line to the data points, which illustratively can be represented with a linear equation of the slope-intercept form y=mx+b, wherein y represents the traffic (e.g., number of events) associated with a given data point and x represents the time interval of the data point (e.g., one day, one hour, five minutes).

After operation 532, the method may end or may return to operation 504 to calculate the required replication capacity for a different hour and/or day.

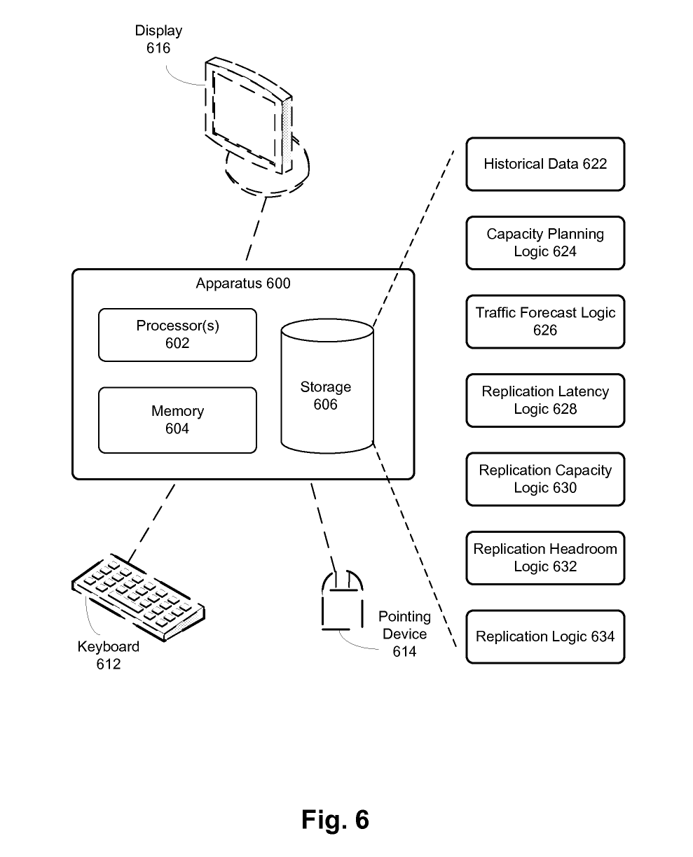

FIG. 6 depicts an apparatus for performing capacity planning, according to some embodiments.

Apparatus 600 of FIG. 6 includes processor(s) 602, memory 604, and storage 606, which may comprise one or more optical, solid-state, and/or magnetic storage components. Storage 606 may be local or remote to the apparatus. Apparatus 600 can be coupled (permanently or temporarily) to keyboard 612, pointing device 614, and display 616. Storage 606 stores historical data 622, which may reflect past traffic rates, observed replication latencies

In addition to historical data 622, storage 606 also stores logic that may be loaded into memory 604 for execution by processor(s) 602. Such logic includes capacity planning logic 624, traffic forecast logic 626, replication latency logic 628, replication capacity logic 630, replication headroom logic 632, and replication logic 634. In other embodiments, these logic modules may be combined or divided to aggregate or divide their functionality as desired.

Capacity planning logic 624 comprises processor-executable instructions for performing capacity planning within apparatus 600 and/or a system in which apparatus 600 operates (e.g., a system that hosts an online application or service). Capacity planning logic 624, when executed, may cause any or all of the various capacity planning parameters discussed above to be calculated (e.g., traffic rate, replication latency, replication capacity, replication headroom, a replication latency metric of a service level agreement).

Also, in the illustrated embodiment, logic 624 serves to generate distribution indexes covering any desired time period (e.g., a week, a day, an hour) with any desired granularity (e.g., hour, five minutes). In other embodiments, this function may be handled by separate logic not depicted in FIG. 6.

Traffic forecast logic 626 comprises processor-executable instructions for forecasting a future traffic rate for some period of time (e.g., a week, multiple weeks, an hour, multiple hours, a day, multiple days). Any suitable model(s) may be applied to generate the forecast. In addition, logic 626 (or some other logic) applies a relevant distribution index to a forecasted rate or amount of traffic in order to produce finer-grained forecasts.

Replication latency logic 628 comprises processor-executable instructions for predicting an expected level or amount of replication latency, based on a forecasted amount/rate of traffic and an expected amount or level of replication capacity.

Replication capacity logic 630 comprises processor-executable instructions for calculating a required level or amount of replication capacity, in terms of how much traffic or how many events must be able to be processed, in light of a traffic forecast, in order to avoid violating an event consumer's service level agreement during a period associated with the forecast.

Replication headroom logic 632 comprises processor-executable instructions for calculating replication headroom that will result from a forecasted level or rate of traffic and an expected replication capacity.

Replication logic 634 comprises processor-executable instructions for replicating events received at apparatus 600 (or at a system that includes apparatus 600) for consumption by event consumers.

In some embodiments, apparatus 600 performs some or all of the functions ascribed to one or more components of system 110 of FIG. 1 (e.g., data storage system 120, event relay module 122).

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method comprising:
receiving electronic events generated during operation of an online service;
replicating the received events for consumption by components of a computer system that hosts the online service;
based on electronic event traffic received during multiple first time periods of a first duration during a historical period of a second duration, generating a distribution index reflecting, for each first time period, a portion of event traffic received during the historical period that was received during the first time period;
based on electronic event traffic received during multiple second time periods of a second duration, forecasting event traffic for one or more future time periods of the second duration; and
applying the distribution index to distribute event traffic forecasted for the one or more future time periods of the second duration among a plurality of future time periods of the first duration.

2. The method of claim 1, further comprising:
for each of the plurality of future time periods, estimating a replication latency to be exhibited during replication of events forecasted to be received during the future time period.

3. The method of claim 2, wherein the replication latency estimated for a given future time period is estimated by:
comparing a forecasted rate of receipt of electronic events during the given future time period with a capacity of the computer system for replicating electronic events during the given future time period; and
adjusting an estimated replication latency accumulated prior to the given future time period based on the comparison.

4. The method of claim 2, wherein the replication latency estimated for a given future time period is estimated based on one of:
a current replication capacity identifying a number of electronic events that can currently be replicated in a unit of time; and
a forecasted replication capacity identifying a number of electronic events that can be replicated in the given future time period.

5. The method of claim 2, further comprising:
for each of the plurality of future time periods, determining a required replication capacity for replicating the events forecasted to be received during the future time period without violating a replication latency metric of a service level agreement.

6. The method of claim 5, wherein the required replication capacity is determined by applying a binary search among candidate replication capacities.

7. The method of claim 5, further comprising:
for each of the plurality of future time periods, estimating replication headroom comprising one or more of:
a factor by which the event traffic forecasted for the future time period can be scaled up without violating the replication latency metric; and
a period of time until the replication latency metric is likely to be violated.

8. The method of claim 1, wherein:
the first duration comprises one hour; and
the second duration comprises one week.

9. A system, comprising:
at least one processor;
a replication module comprising a first non-transitory computer readable medium storing instructions that, when executed by the at least one processor, cause the system to:
receive electronic events generated during operation of an online service hosted by the system; and
replicate the received events for consumption by components of the system; and
a traffic forecast module comprising a second non-transitory computer readable medium storing instructions that, when executed by the at least one processor, cause the system to:
based on electronic event traffic received during multiple first time periods of a first duration during a historical period of a second duration, generate a distribution index reflecting, for each first time period, a portion of event traffic received during the historical period that was received during the first time period;
based on electronic event traffic received during multiple second time periods of a second duration, forecast event traffic for one or more future time periods of the second duration; and
apply the distribution index to distribute event traffic forecasted for the one or more future time periods of the second duration among a plurality of future time periods of the first duration.

10. The system of claim 9, further comprising:
a replication latency module comprising a third non-transitory computer readable medium storing instructions that, when executed by the at least one processor, cause the system to:
for each of the plurality of future time periods, estimate a replication latency to be exhibited during replication of events forecasted to be received during the future time period.

11. The system of claim 10, wherein the replication latency estimated for a given future time period is estimated by:
comparing a forecasted rate of receipt of electronic events during the given future time period with a capacity of the computer system for replicating electronic events during the given future time period; and
adjusting an estimated replication latency accumulated prior to the given future time period based on the comparison.

12. The system of claim 10, further comprising:
a replication capacity module comprising a fourth non-transitory computer readable medium storing instructions that, when executed by the at least one processor, cause the system to:
for each of the plurality of future time periods, determine a required replication capacity for replicating the events forecasted to be received during the future time period without violating a replication latency metric of a service level agreement.

13. The system of claim 12, further comprising:
a replication headroom module comprising a fifth non-transitory computer readable medium storing instructions that, when executed by the at least one processor, cause the system to:
for each of the plurality of future time periods, estimate replication headroom comprising one or more of:
a factor by which the event traffic forecasted for the future time period can be scaled up without violating the replication latency metric; and
a period of time until the replication latency metric is likely to be violated.

14. The system of claim 9, wherein:
the first duration comprises one hour; and
the second duration comprises one week.

15. An apparatus, comprising:
one or more processors;
logic comprising instructions that, when executed by the one or more processors, cause the apparatus to:
receive electronic events generated during operation of an online service hosted by the apparatus;
replicate the received events for consumption by components of the apparatus;
based on electronic event traffic received during multiple first time periods of a first duration during a historical period of a second duration, generate a distribution index reflecting, for each first time period, a portion of event traffic received during the historical period that was received during the first time period;
based on electronic event traffic received during multiple second time periods of a second duration, forecast event traffic for one or more future time periods of the second duration; and
apply the distribution index to distribute event traffic forecasted for the one or more future time periods of the second duration among a plurality of future time periods of the first duration.

16. The apparatus of claim 15, wherein the logic further comprises instructions that, when executed by the one or more processors, cause the apparatus to:
for each of the plurality of future time periods, estimate a replication latency to be exhibited during replication of events forecasted to be received during the future time period;
for each of the plurality of future time periods, determine a required replication capacity for replicating the events forecasted to be received during the future time period without violating a replication latency metric of a service level agreement; and
for each of the plurality of future time periods, estimate replication headroom comprising one or more of:
a factor by which the event traffic forecasted for the future time period can be scaled up without violating the replication latency metric; and
a period of time until the replication latency metric is likely to be violated.

17. The apparatus of claim 16, wherein:
the first duration comprises one hour; and
the second duration comprises one week.
